(19) United States
(12) Patent Application Publication
(10) Pub. No.: US 2015/0142831 A1
(43) Pub. Date: May 21, 2015

(54) COMPUTERIZED METHOD AND A COMPUTER PROGRAM RPODUCT FOR DETERMINING A RESULTING DATA SET REPRESENTATIVE OF A GEOLOGICAL REGION OF INTEREST

(71) Applicants: TOTAL SA, Courbevoie (FR); CGGVERITAS SERVICES SA, Massy (FR)

(72) Inventors: Francis Clement, Pau (FR); Daniel Trad, Calgary (CA)

(73) Assignees: TOTAL SA, Courbevoie (FR); CGGVERITAS SERVICES SA, Massy (FR)

(21) Appl. No.: 14/396,676

(22) PCT Filed: Oct. 15, 2012
(86) PCT No.: PCT/EP2012/070410

§ 371 Date: Oct. 23, 2014

Related U.S. Application Data
(60) Provisional application No. 61/637,465, filed on Apr. 24, 2012.

(51) Int. Cl. G06F 17/30

(52) U.S. Cl. CPC G06F 17/30572; G06F 17/30371
USPC 707/754

(57) ABSTRACT

A computerized method where one provides first and second data sets, representative of the geological region of interest, each associating a signal to a bin of a four-dimensional input grid of the region of interest. Then one interpolates the first data set to determine both an interpolated first data set and interpolation operators. A residual between the second data set and the interpolated first data set is then determined. The residual is interpolated using said interpolation operators to determine an interpolated residual.

### RELATED APPLICATIONS

The present application is a National Phase entry of PCT Application No. PCT/EP2012/070410, filed Oct. 15, 2012, which claims priority from U.S. Patent Application No. 61/637,465, filed Apr. 24, 2012, said applications being hereby incorporated by reference herein in their entirety.

### FIELD OF THE INVENTION

The instant invention relates to computerized methods and computer program products for determining a resulting data set representative of a geological region of interest.

### BACKGROUND OF THE INVENTION

In particular, the instant invention is related to treatment of seismic imaging data sets.

All current 3D seismic acquisition geometries have poor sampling along at least one dimension. There are many different approaches to tackling this problem. The only perfect solution is to acquire well-sampled data; all other approaches deal with the symptoms of the problem rather than the problem itself, and there is no guarantee that they can adequately solve it. However, given that, in the real world, it usually is not possible to go back to the field and fix the actual problem, this issue needs to be addressed using processing tools.

There is therefore always a need to improve the treatment of seismic imaging data. Further, even though computing powers have improved, there is still a need to provide computing-friendly methods when handling the data.

### SUMMARY OF THE INVENTION

To this aim, it is provided a computerized method for determining a resulting data set representative of a geological region of interest comprising:
providing a first and a second data sets, each representative of the geological region of interest, each associating a signal to bins of a four-dimensional input grid of the region of interest, wherein each bin of the four-dimensional input grid comprises coordinates of a source and a detector associated to the signal,
interpolating the first data set to determine both an interpolated first data set and interpolation operators by which the interpolated first data set corresponds to the first data set,
determining a residual between the second data set and the interpolated first data set,
interpolating the residual using said interpolation operators to determine an interpolated residual,
obtaining a resulting data set at least from the interpolated residual.

With this method, it is benefited from the computationally intense generation of the interpolation operators to treat the residual data. Therefore, a relevant resulting data set can be generated at low computational cost.

In some embodiments, one might also use one or more of the features as defined in the claims.

### BRIEF DESCRIPTION OF THE DRAWINGS

Other characteristics and advantages of the invention will readily appear from the following description of four of its embodiments, provided as non-limitative examples, and of the accompanying drawings.

On the drawings:

FIG. 1 is a perspective view of a geological region of interest,

FIG. 2 is a top schematic view of the region of FIG. 1,

FIGS. 3a-3d are diagrammatic views of 4 examples of implementation of the method,

FIG. 4 is a perspective view of an apparatus suitable to perform the method,

FIG. 5a shows migration results from original data,

FIG. 5b shows the data after being submitted to processing, and

FIGS. 6a and 6b show outputs of the present method applied to the data sets of FIG. 5a according to two different embodiments.

On the different Figures, the same reference signs designate like or similar elements.

### DETAILED DESCRIPTION

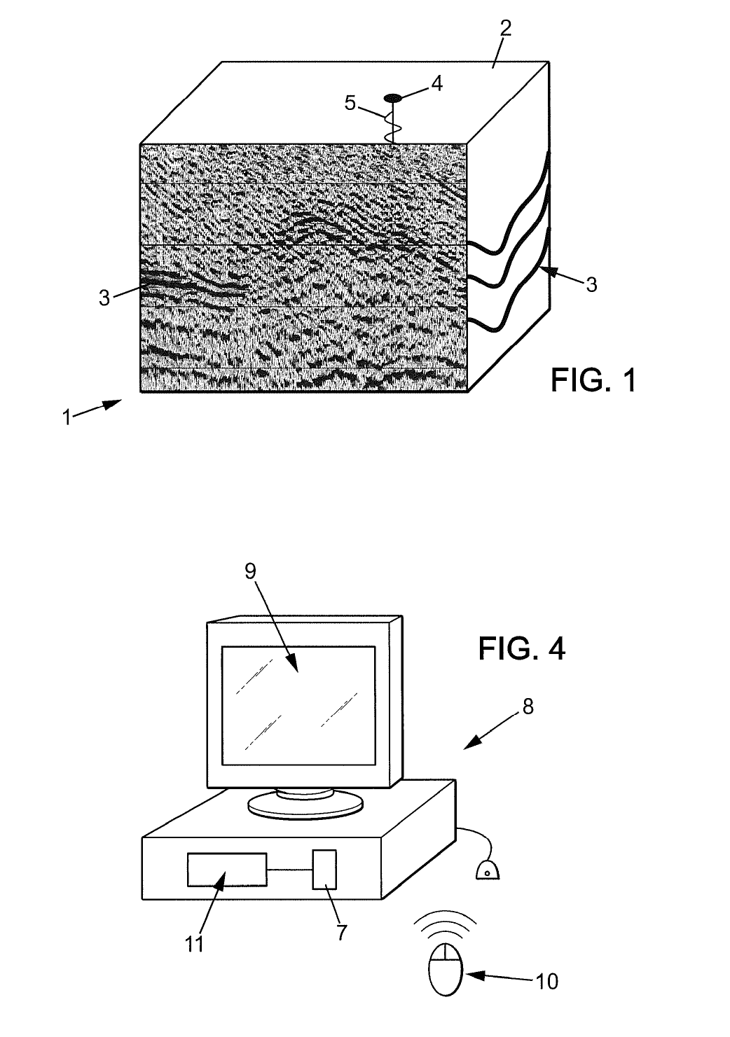

FIG. 1 schematically shows a geological region of interest 1. This region of interest 1 has a top surface 2, which can for example be the ground level, or the sea bottom, for example. The geological region of interest is typically many kilometer long in every three directions of space. It comprises 3D structures 3, a section of which are shown in details on the front face of the region 1, and schematically on the right face of FIG. 1. The presently described method has for primary aim to be able to obtain usable information about these structures.

A common method to obtain information about this structure is seismic imaging. One or more sources 4 may emit waves 5 into the structure, and the reflection of these waves by the geological region of interest can be detected and processed to obtain information about the region of interest.

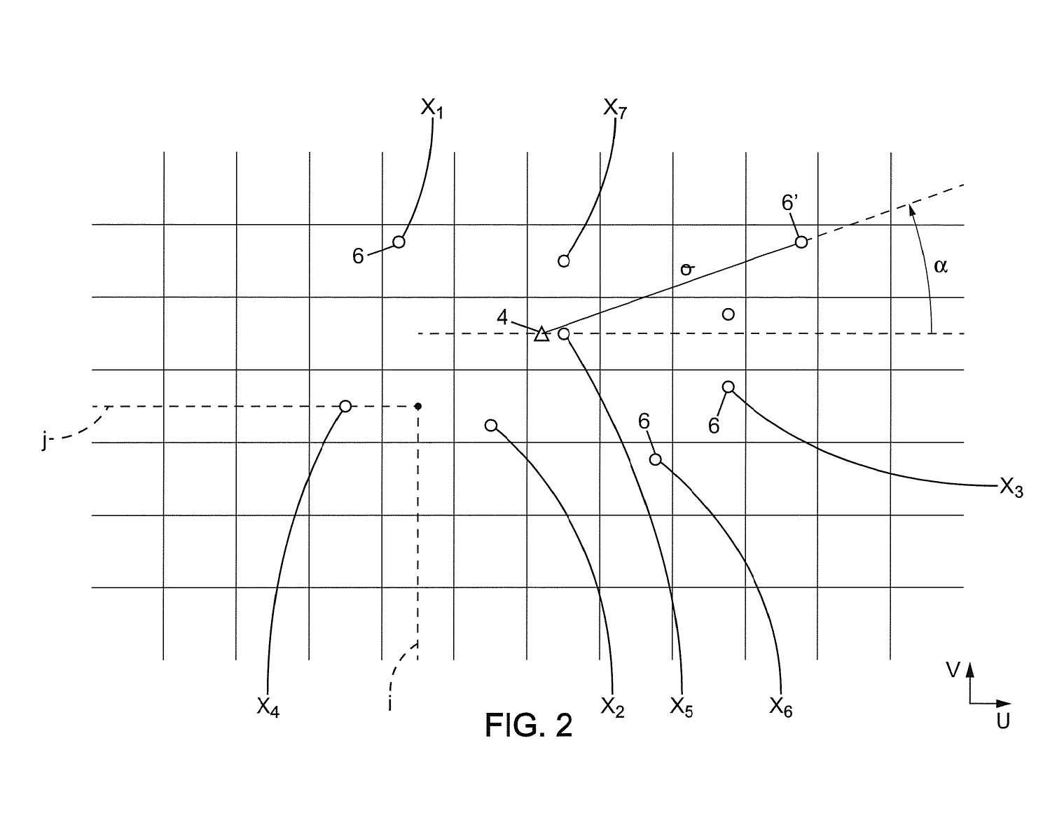

As a purely illustrative embodiment, FIG. 2 shows a top view of the region of interest. In view of the scale of the involved phenomena, in the present description, the top surface 2 will be assumed planar, however, the present method may also work taking into account position variations about the vertical axis.

The surface 2 is meshed into bins, which are defined by their coordinates (i;j) along two orthogonal axis U-V in the plane of reference.

One source 4 is shown with a triangle. It is located in a given bin. During a seismic imaging experiment, one uses receptors 6. The following description is done with respect to the receptor identified by reference 6′ on FIG. 2. When a signal is emitted by the source 4, the detector 6′ will record a trace signal as a function of time. The trace signal is a function of the position of the detector 6′, but also of the position of the source 4. Rather than using these four input variables, one may also use as variables the position of the detector and the relative positions of the detector and the source. These later may be expressed as offset (o), representing the distance between the source and receptor, and azimuth (a), representing an angle in the [0; 360°] range between the source-detector axis and an axis of reference (here parallel to U). The detected trace depends on time, which can be linked with the depth of the reflecting structure, taking into account the propagation speed of the waves in the region of interest. The detected signals, each associated with a four-dimensional input, form a data set.

For example, in a first embodiment, one uses three receptors, which are located in positions X₁, X₃ and X₆, which are each located in a respective bin. In seismic imaging, it is often difficult to place receptors everywhere. Therefore, extrapolation might be needed to estimate data related to areas of the region of interest for which scarce data is available.

Further, like any measurement, the detected signal comprises a given noise. Even though data processings (filtering) are known which can reduce the level of noise on the detected signals, such processing may also obliviate relevant data.

Therefore, a proper balance between interpolation and filtering is sometimes difficult to achieve.

According to a first embodiment, it is proposed a technique for combining two different data sets into new data containing common features of the two inputs. Although many applications of this tool are possible, a first embodiment can be to recover signal that has been eliminated, attenuated or distorted by application of aggressive processing (filtering). This is a common problem in seismic processing because of the difficulty of achieving a proper balance between noise attenuation and signal preservation. Aggressive noise attenuation affects signal, in particular amplitudes, while gentile processing leaves noise on the data. With the proliferation of techniques that use amplitude variations with offset or/and azimuth (AVO or AVAz) this has become a serious problem and considerable effort is spent to achieve amplitude compliant techniques. Tools like the one proposed here propose a way of releasing this constraint by providing a way to undo signal distortion.

After aggressive processing of a noisy data set, it is desired to restore coherent features or signal that was distorted by the processing, including both amplitudes and travel times. The method proposed here is based on combining Five Dimensional (5D) interpolation of the two data sets in one inversion. 5D Interpolation is a technique used to infill acquired data by creating a 5-dimensional model of the wave field through Fourier Inversion. The five dimensions mentioned here are the four spatial dimensions mentioned above (location of detector (x, y, offset and azimuth with respect to the source), and time along the detected trace signal. The present method is an adaptation of a 5D interpolation algorithm to apply a correction on the output to account for amplitude and traveltime differences with the original data. The cost of the present method is almost equal to the cost of 5D interpolation of one of the data sets, and has the advantage of allowing combining datasets with different geometries.

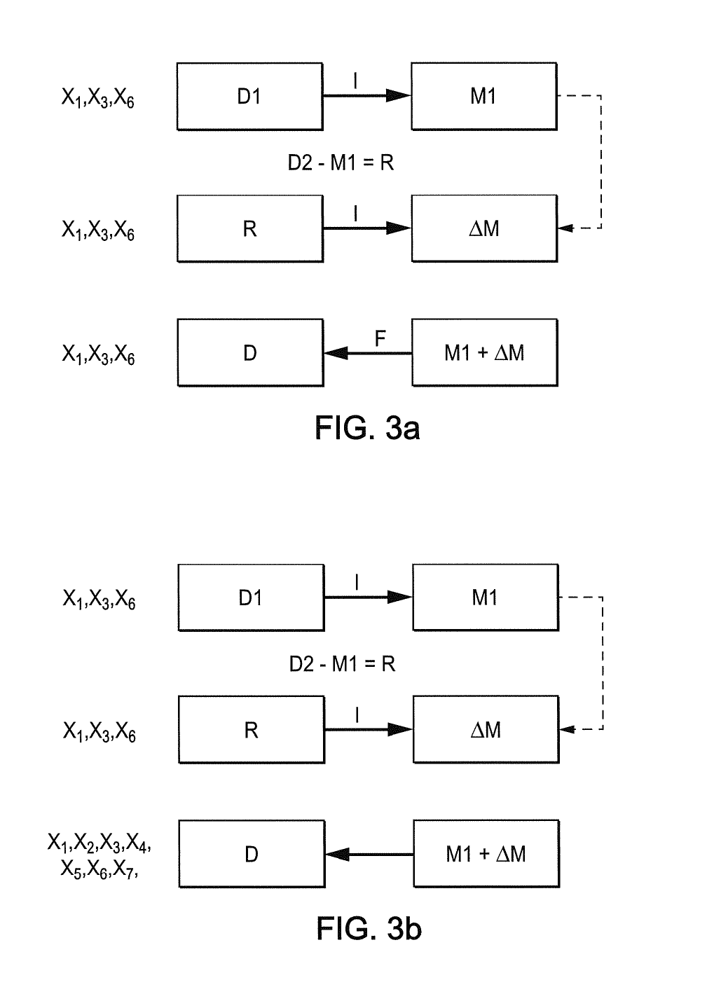

One example of the method is given below, where bold letters corresponds to four dimensional matrices (one per spatial direction), in relation to FIG. 3a:

a) It is provided as input a data set d2, for example corresponding to the measured data set (obtained from trace signals measured in X₁, X₃ and X₆).

b) Then, one generates an other data set d1, by processing (filtering) the data set d2. This other data set d1 is hence obtained for the same locations.

c) One performs an interpolation I of the other data set d1. For every temporal frequency (slice) of data, one applies 5D interpolation on d1 to solve for the fully sampled wavefield m1 by minimizing the cost function J (“Five-dimensional interpolation: Recovering from acquisition constraints”, GEOPHYSICS, VOL. 74, NO. 6 NOVEMBER-DECEMBER 2009_; P. V123V132, Trad, 2009):

J=∥d1−Lm1∥+∥Wm1∥ (1)

where L is the sampling operator that maps the full wavefield m1 to the geometry of d1 and W is the multidimensional spectral information of the data d1 mapped to all space.

∥d1−Lm1∥ is a data misfit function, which quantifies how different from the data d1 the product Lm1 is.

∥Wm1∥ is the model norm which can be determined as explained below.

The discrete Fourier transform of m1 can be written as (k=1 . . . N) along each dimension:

M1ₖ=(N)^{-1/2}Σ_{(n=1 . . . N)}m1ₙe^{-i2π(n-1)(k-1)/N}, (2)

Where N is the total number of locations where data is to be interpolated along said dimension, and I the complex number such as i²=−1.

The inverse discrete Fourier transform of m1 can be written as (j=1 . . . N):

m1ⱼ=(N)^{-1/2}Σ_{(k=1 . . . N)}M1ₖe^{i2π(j-1)(k-1)/N}. (3)

Equations (2) and (3) can be written in matrix form as M1=F·m1 and m1=F^{H}·M1, where ^{H} designates the complex conjugate transpose.

An appropriate solution to the interpolation problem is one which minimizes a model norm ∥Wm1∥. We can for example select the following model norm:

∥Wm1∥=Σ_{(k in K)}(M1*ₖM1ₖ)/(Pₖ²) (4)

Where M1*ₖ is the complex conjugate of M1*ₖ, Pₖ² are the spectral domain weights with support and shape similar to those of the signal to interpolate. The set of indexes K indicates the region of spectral support of the signal. The coefficient Pₖ represents the spectral power at the wavenumber index k (which is then different from 0 for each k in K).

W is a 4D-diagonal matrix with Wₖ=Pₖ², and W⁺is a 4D-diagonal matrix where the non-zero values of W are replaced by their inverse.

Hence, ∥Wm1∥ can be written as follows:

∥Wm1∥=m1^{T}·F^{T}·W⁺·F·m1 (5),

Where ^{T} represents the transpose.

This is the expensive part of the algorithm and typically takes around 50-100 iterations per frequency. The output of this step will be both the interpolated first data (in the form of the model m1) and the interpolation operators L and W.

d) Then, one calculates residuals between the data set d2 and the interpolated guide:

R=d2−m1(d1) (6),

where m1(d1) means the wave field m1 evaluated on the positions of d1. In the present case where d1 and d2 are provided for the same bins, the residual could simply be

R=d2−d1.

e) Then, one performs interpolation of the residuals by partially solving the least squares algorithm (truncated solution):

J=∥R−LΔm∥+∥WΔm∥ (7)

where Δm is the result of the inversion and contains the coherent part of the difference between the guide and the original data set. This is the part of signal that has been eliminated by aggressive noise attenuation. The interpolation operators, and notably the spectral weights W, are obtained from the interpolation of the guide above, because the assumption is that the guide has better signal to noise ratio than the data.

f) Then, the amplitude correction obtained as a solution for the residuals is added to the solution for the guide:

m=m1+Δm (8)

g) Finally, a resulting data set can be obtained by forward modelling, i.e. by applying

D=L(m1+Δm) (9),

where L is the sampling operator calculated above.

According to this method, the resulting data set can be estimated only at the locations where the data set is measured. In this way, the quality of the resulting data set is improved by the filtering, but not as harshly as d1 is. Hence, the interpolation is used mainly to determine the interpolation operators, but not to expand the data set to areas where no data was measured (the interpolation is not an extrapolation).

An approach that often works in practice is extracting coherent energy from the difference between input and output and adding it back to the output. The technique proposed here incorporates this ad-hoc procedure into an optimization algorithm in five dimensions.

According to a second embodiment, as shown on FIG. 3b, the first steps of the method are similar. However, one may benefit from the fact that the model m1+Δm is defined for the whole geometry to extrapolate the output data set to other bins of the grid, such as, for example X₂, X₄, X₅ and X₇.

In the first embodiment, the data set d1 could be obtained by processing the measured data set d2. However, in a third embodiment, this is not necessarily the case. One may have two different data sets d1 and d2 of a given region of interest. These two data sets could for example be obtained from two different imaging periods. Notably, in such cases, the bins of both data sets might be different, as shown on FIG. 3c: The first data set could be obtained for bins X₁, X₃, X₆ and the second data set could be obtained for bins X₂, X₃, X₇ (maybe totally separated or partly superimposed with the bins of the first data set, as in the present case).

In such case, in case of calculating m1(d1) as the wave field m1 evaluated on the positions of d1, one calculates m1(d2) as the wave field m1evaluated on the positions of d2, and the residual R is estimated at these locations as R=d2−m1(d2). The rest of the process is similar, and the resulting data set can be estimated for the bins of d1, those of d2, or elsewhere.

According to a fourth embodiment, as shown on FIG. 3d, one may estimate Am as disclosed above for any of the embodiment. According to this fourth embodiment, d2 would be a data set obtained a given time after d1 (for the same bins or not). Am could be used to reflect the changes of the reservoir in the geological region of interest.

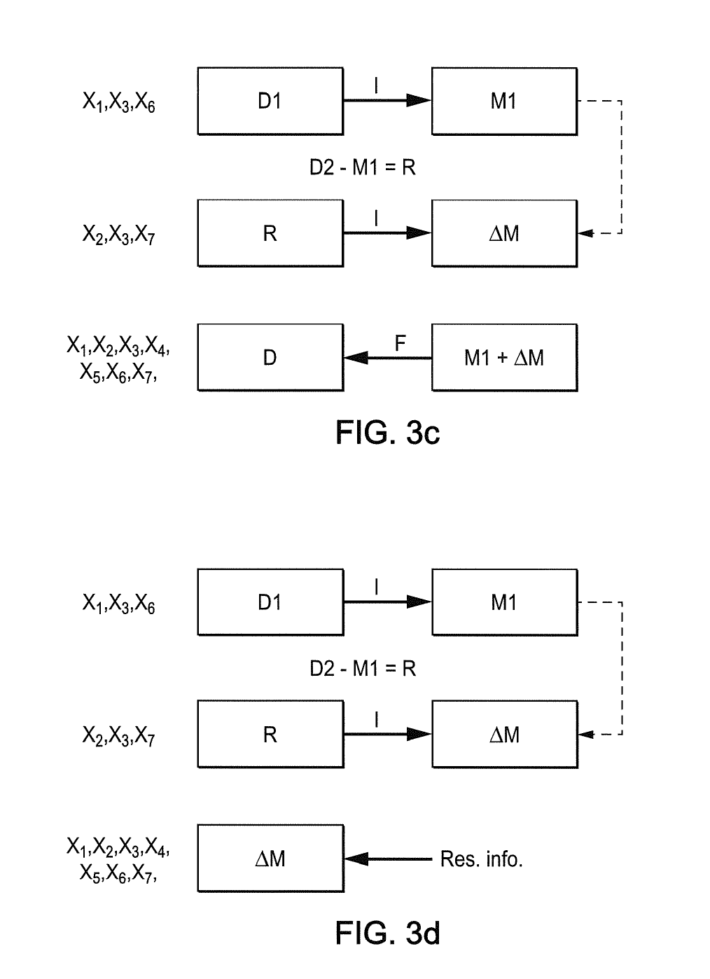

As shown on FIG. 4, the above method can be carried out on a programmable machine such as a processor 11 having access to a memory 7 containing the data set(s). The processor and the memory can be provided on the same machine 8, or distributed over a network, possibly among different countries. A display 9 can be provided so that a user can set some parameters of implementation of the above methods and/or display some results. The user may use an interface 10 to communicate with the processor 11.

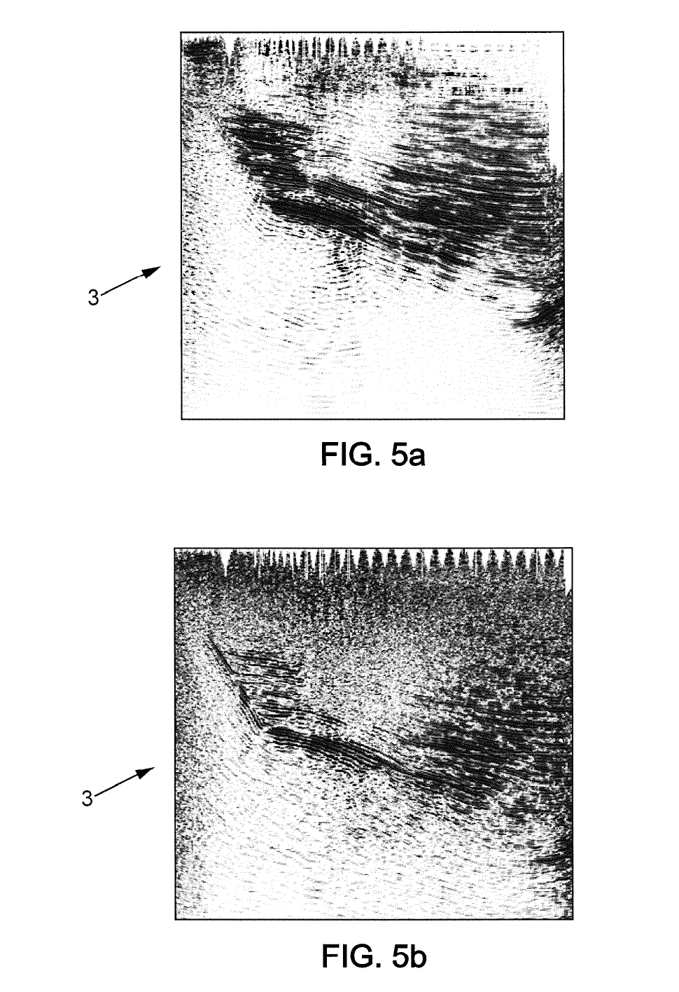

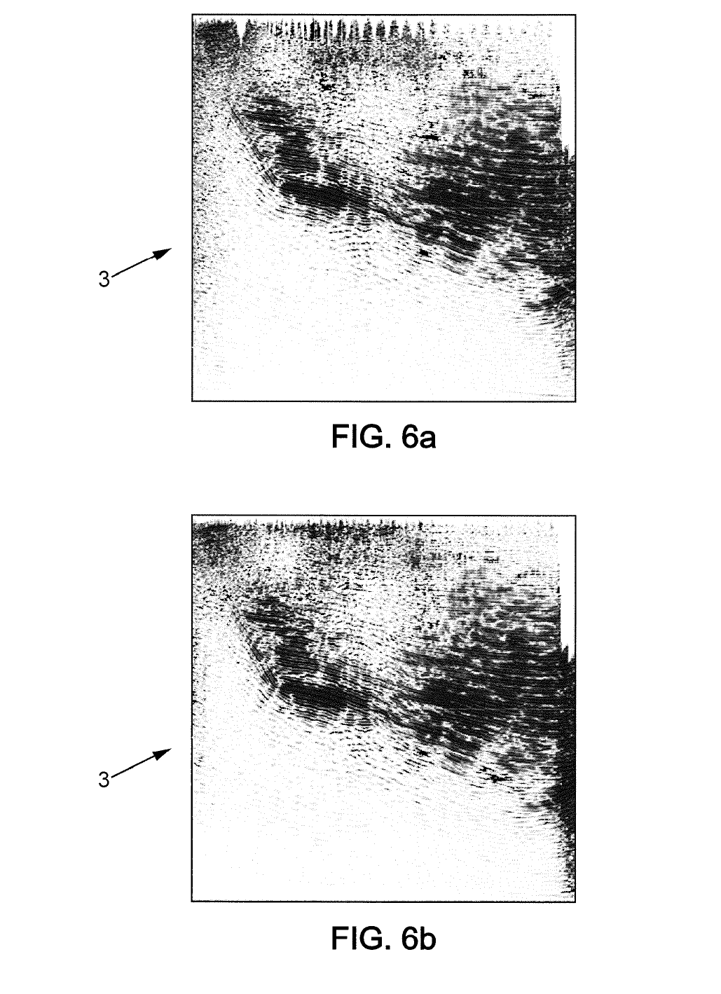

FIG. 5a shows prestack time migration results of the original data d1. FIG. 5b shows migration results of the guide data d2 on this case obtained by Common Reflection Stack (CRS) processing. FIG. 6a-b show migration results of the gathers obtained using the above method. In FIG. 6a the gathers are on the same geometry as the d1 and d2. In FIG. 6b, the gathers have been created on a new geometry with half the shot and receiver line spacing of the input.

Notice that
The data and the guide can be on different geometries since they are only connected through m which is sampled everywhere.
Interpolation of residuals is done with very few iterations and therefore adds only an small cost to the interpolation (typically around 5%).
The model m can be used to predict data on any geometry, which makes interpolation or regularization a sub product of the process. If the only purpose of the application is to recover or match amplitudes then the forward modelling is done on the input locations.

According to one embodiment, this technique can permit to recover signal that has been eliminated or destroyed by aggressive processing. This permits the use of noise attenuation tools that may be considered too harsh to use in projects where amplitude preservation is essential (AVO, AVAz). By adjusting the number of iterations performed on the residuals, it is possible to obtain a new data set that is closer to the first or the second data set.

Cost of the process is similar to interpolation of one data set even when the interpolation for the two data sets is performed.

The process is geometry independent, and therefore it can be used as well to combine two different data sets acquired on the same area.

The above method is a technique the combines 5D interpolation of two data sets. The product contains features that belong to the first data set but corrected or modified in such a way that differences with the second data set are minimized in a multidimensional sense. Having a technique to recover coherent information destroyed during the processing permits users to use tools which are more effective to remove noise.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. A computerized method for determining a resulting data set representative of a geological region of interest, wherein the method comprises:
providing a first and a second data sets, each representative of the geological region of interest, each associating a signal to a bin of a four-dimensional input grid of the region of interest, wherein each bin of the four-dimensional input grid comprises coordinates of a source and a detector associated to the signal,
interpolating the first data set to determine both an interpolated first data set and interpolation operators by which the interpolated first data set corresponds to the first data set,
determining a residual between the second data set and one of the first data set and the interpolated first data set,
interpolating the residual using said interpolation operators to determine an interpolated residual, and
obtaining a resulting data set at least the interpolated residual.

2. The computerized method according to claim 1, wherein one determines the residual between the second data set and the interpolated first data set.

3. The computerized method according to claim 1, wherein the resulting data set is obtained from the interpolated residual and at least one of the interpolated first data set and the first data set.

4. The computerized method according to claim 3, wherein the method is further repeatedly implemented using the resulting data set from a previous iteration as the first data set of a further iteration.

5. The computerized method according to claim 1, wherein the first and a second data sets are obtained for different times of operation of the geological region of interest, and the resulting data set comprises a map of the evolution of the reservoir of the geological region of interest between these times.

6. The computerized method according to claim 1, wherein interpolating comprises determining, for at least one frequency slice, a sampling operator that links the first data set anti the interpolated first data set, and spectral weights of the first data set,
wherein said interpolation operators comprise said sampling operator and spectral weights.

7. The computerized method according to claim 1, wherein interpolating comprises determining an interpolated data set on a finer four-dimensional input grid than the four-dimensional input grid of the first data set.

8. The computerized method according to claim 1, wherein the first and second data sets are provided on the same four-dimensional input grids.

9. The computerized method according to claim 8, further comprising obtaining the first data set from the second data set b filtering the second data set.

10. All The computerized method according to claim 1, wherein the first and second data sets are provided on different respective first and second four-dimensional input grids, and wherein determining a residual involves estimating the interpolated first data set on the second four-dimensional input grid.

11. The computerized method according to claim 1, wherein the four-dimensional input grid comprises spatial coordinates of a receiver in a plane, and spatial coordinates of a difference of location between the receiver and a source in the plane, wherein the data set comprises a signal received by said receiver associated to an emitted signal by the source.

12. A computer program product comprising instructions to cause a programmable machine to execute the steps of claim 1 when said product is run on the programmable machine.
